(19) United States
(12) Patent Application Publication
(10) Pub. No.: US 2006/0086894 A1
(43) Pub. Date: Apr. 27, 2006

(54) Security door

(75) Inventor: Peter Shepherd, East Sussex (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Gunnebo Mayor Ltd.

(21) Appl. No.: 10/497,439

(22) PCT Filed: May 11, 2004
(86) PCT No.: PCT/GB04/02008

§ 371 Date: Jun. 2, 2004

(30) Foreign Application Priority Data
May 13, 2003 (EP) 03252958.8

(51) Int. Cl. G06M 7/00; B60R 25/00; G08B 13/18

(52) U.S. Cl. 250/221; 340/5.7; 340/555

(57) ABSTRACT

A system for monitoring the passage of people through a controlled location, the system comprising: a security access device for selectively allowing and preventing the passage of one or more people through the controlled location; an array of imaging sensors which, in use, emit a curtain of light and detect reflected light from people through the curtain of light to generate image data; and, processing means for analysing characteristics of the reflected image data for each sensor in the array and controlling the operation of the security access device in dependence on the analysis, wherein the processing means determines at least one of the following characteristics for the array of sensors; duration of signal from each sensor, number of signals for each sensor and the saturation of the array.

### FIELD OF THE INVENTION

This invention relates to a system for monitoring the passage of people through a controlled location, such as a security door, with interlocking or synchronised doors or with other means, such as turnstiles, flaps or other obstacles for controlling access to a secured area.

### BACKGROUND OF THE INVENTION

A typical security door may comprise a revolving door divided into, for example, four compartments by radially extending wings. The wings are coupled centrally at their upper and/or lower end to an interlock operated by a control system and are typically motor driven, but may alternatively be pushed manually. Turnstile systems are generally free to be pushed manually.

The control system may operate, for example, in response a card reader or other access control means such as an alphanumeric authorisation code, identity confirmation means, such as fingerprint or retinal scans, or even voice recognition. In the example of a card reader, an authorised person wishing to pass through the door will then insert their pass card into a reader and, provided that their card is recognised, the control system then operates the interlock to free the revolving door so that the user can pass through. If the card is not recognised, or if an unauthorised person attempts to gain access without the use of the pass card, then the interlock holds the wings of the revolving door against movement and so prevents passage through the door.

Known security doors suffer from a number of potential forms of misuse. In particular, they are vulnerable to “piggy backing” in which two or more individuals attempt to pass through the door in one compartment although only one authorised passage has been allowed and to “tail-gating” in which an unauthorised person enters the compartment immediately following the one containing the authorised person or, alternatively, passes through the door in the opposite direction to and at the same time as the authorised person. Previously suggested means, such as pressure sensitive doormats in a security door, or the use of ultrasonic sensors detect the presence of more than one person in the door, have not been wholly successful in preventing the above problems.

Accordingly, the present invention aims to provide a system in which the above-mentioned problems can be prevented, or, at the very least, significantly reduced.

### SUMMARY OF THE INVENTION

According to the present invention, there is provided a system for monitoring the passage of people through a controlled location, the system comprising:

a security access device for selectively allowing and preventing the passage of one or more people through the controlled location;

an array of imaging sensors which, in use, emit a curtain of light and detect reflected light from people through the curtain of light to generate image data; and

processing means for analysing characteristics of the reflected image data for each sensor in the array and controlling the operation of the security access device in dependence on the analysis;

wherein the processing means determines at least one of the following characteristics for the array of sensors; duration of signal from each sensor, number of signals for each sensor and the saturation of the array.

Thus, the present invention provides a means, in the form of a “curtain” of light, through which any person entering or leaving the controlled location must pass such that it is not possible to avoid detection, thereby enabling the processing means to determine whether or not the correct number of people are passing through the security access device in the appropriate direction. The imaging sensors are such that they both emit and deflect light, thereby ensuring that additional components are not required. These sensors are active sensors, rather than passive as would be the case in conventional thermal imaging for example.

The imaging sensors may continuously emit the light, the processing means then being able to distinguish between the passing of portions of a door or other obstacle in the security access device and one or more persons passing through the controlled location, or even be suitably timed so as to Ignore the door.

It is preferable that the light emitted by the sensors is in the infra red region.

The array of imaging sensors which emit the curtain of light are preferably located so as to detect the entrance of one or more persons into the controlled location, typically in the ceiling of the device. A second array of sensors may be located so as to detect the exit of a person from the controlled location, again typically in the ceiling.

The security access device is preferably a revolving door, but may take the form of a turnstiles or other appropriate security access device.

The array of sensors which emit the curtain of light may be formed by a row of at least three sensors, preferably 5 sensors, depending upon door size. The height and length at which the beams focus can be adjusted.

The second array preferably comprises two sensors, although a greater number can be used in the event that the security access device is unusually large. The second array of sensors are for confirming passage through the unit and also to act as so called “trapped man” detectors should someone enter the controlled location from the wrong direction during a rejection sequence.

The system may also further comprise drive means for rotating and/or preventing rotation of the door, in response to signals from the processing means.

If one or more of the array characteristics described are detected, the processor will initiate a controlled stopping of the unit within 85 to 90° of the initial start point. The controller will then automatically reverse at half speed to reject the person or persons out of the unit and then become available for use in the correct manner, i.e. authorised single passage per quadrant.

The present invention also provides a method of monitoring the passage of people through a controlled location, the method comprising the steps of:

emitting a curtain of light through which any person moving through the controlled location must pass;

sensing the number of people on a portion of the controlled location;

determining whether to allow or prevent passage through the controlled location; and

driving a security access device to allow or prevent passage through the controlled location in response to the determination.

The present invention also provides a system of monitoring the passage of people through a controlled location, the system comprising:

means for emitting a curtain of light through which any person moving through the controlled location must pass;

means for sensing the number of people in a portion of the controlled location;

means for determining whether to allow or prevent passage through the controlled location; and

means for driving a security access device to allow or prevent passage in response to the determination.

### BRIEF DESCRIPTION OF THE DRAWINGS

Examples of the present invention will now be described in detail with reference to the accompanying drawings, in which:

FIG. 1 is a schematic elevation of a security door;

FIG. 2 is a schematic cross sectional plan view of the door of FIG. 1.

FIG. 3 is a schematic plan view of the top of the door of FIG. 1;

FIGS. 4a and 4b show two arrangements of an array of sensors on entry to the door;

FIGS. 5A to D show schematic views of the door during operation;

FIG. 6 shows a schematic view of the door in an emergency situation;

FIGS. 7 to 11 show test results and data analysis from a five sensor array on entry to the device, generated by the processing means and indicative of different scenarios; and

FIGS. 12 to 14 show further test results and data analysis operated by control software.

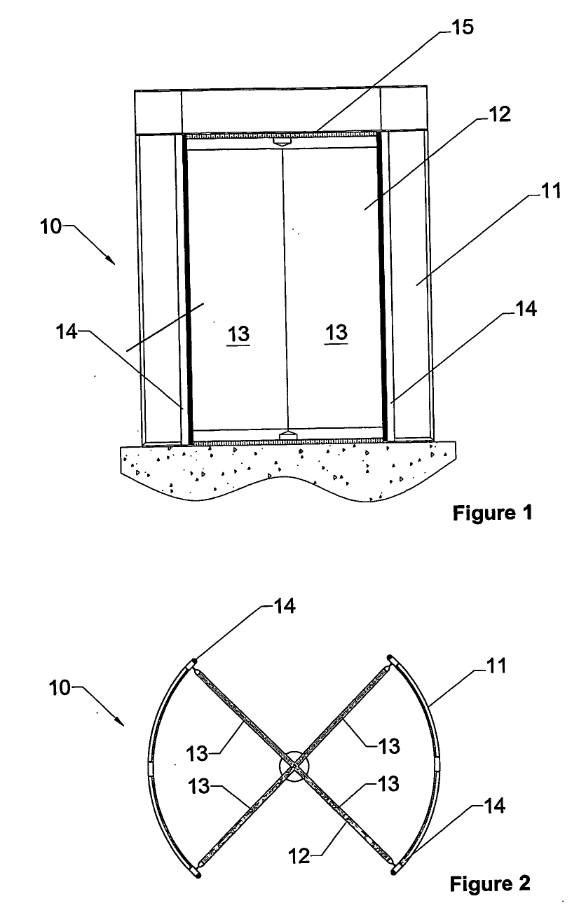

### DETAILED DESCRIPTION

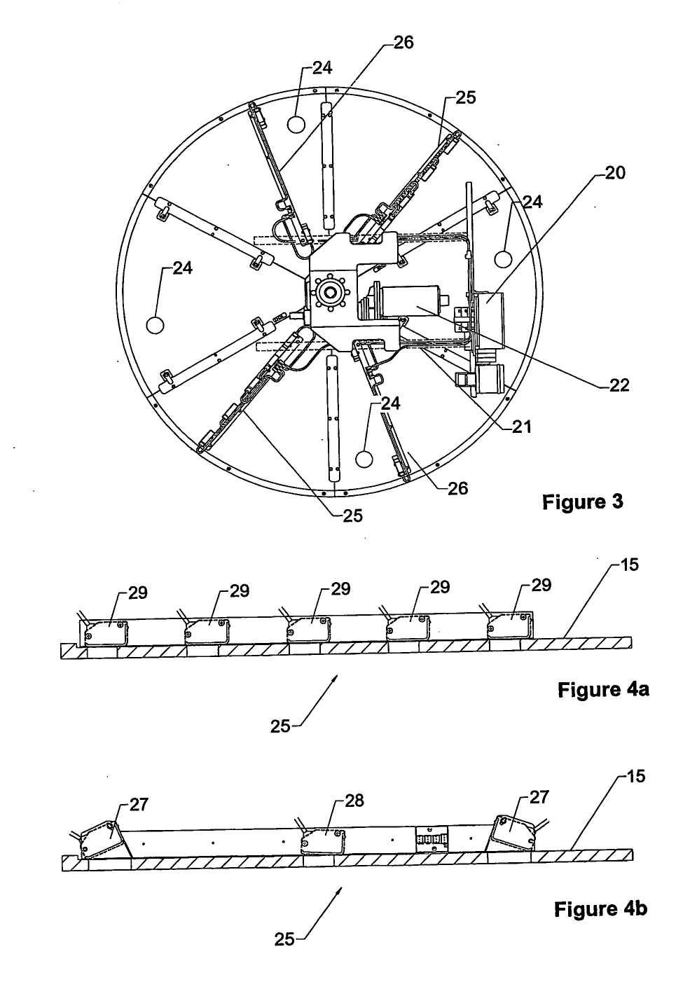

A security access device 10 is shown in FIG. 1 and is provided with a security door 11 comprising a revolving door member 12 having four wing members 13 equally spaced at 90° intervals, thereby defining four quadrants. Whilst four wing members are preferable, it is envisaged that any suitable number may be used. The security door 11 also comprises two outer body parts 14 on opposite sides of the security door, each outer body part 14 extending over an arc which is at least the same as that between adjacent wing members 13. A drive unit 20, see FIG. 3, is provided in the ceiling 15 of the door, the drive unit initiating and driving the motion of the revolving door member. The drive unit incorporates an interlock such that, when not in use, the revolving door member 12 is prohibited from revolving.

FIG. 3 shows a schematic arrangement of the components in the ceiling 15 of the security access device 10. The drive unit 20 is mounted in the ceiling 15 via several mounting locations (not shown), such that a motor 22 is located above the revolving door member 12.

The drive unit 20 is preferably shock mounted on to a motor mounting frame 21 and attached to the door. The mounting means provide protection from damage due to sudden shock to the wing assembly and they extend the life of the gear reduction unit (not shown) by cushioning the shock generated when the motor is started. A number of downwardly pointing lights 24 are provided to illuminate the area inside the envelope of the security access device.

The drive system is located in the canopy directly above the revolving door 12. It comprises the motor 22, the primary and secondary reduction units and the collector ring, which powers electromagnetic shear locks, which are utilised in a break out wing variant for use in emergency situations. Alternatively the collector ring may be omitted in a fixed wing arrangement. The drive system additionally includes a motor encoder and a secondary positioning sensor which provide information on the position of the revolving door to the drive system controller.

The drive unit is, in this example, controlled by a microprocessor mounted in the electrical plate assembly 29. A motor shaft mounted encoder can accurately position the motor and wings by counting the encoder graduations in a well known manner. A timing disk and position sensor is mounted on the underside of the gear box to determine the “home” and “emergency” positions. The sensor is typically static mounted to the gear box housing whereas the timing disk is clamped to the rotor spindle on the axis 23, thus allowing adjustments to be made to the orientation of the wings.

In the arrangement shown in FIG. 3, access through the device is either from left to right or, alternatively, from right to left. The revolving door member 12 (not shown) is intended to rotate, in the usual manner, in a counterclockwise direction, such that a person passing from the right to the left through the device utilises the upper half and a person passing from left to right utilises the bottom part of the door. Accordingly, an array of entry sensors is located such that any person entering the door must pass under this array. The array extends substantially radially from the axis 23 to the outer circumference of the door defined by the outer body parts 14. Exit arrays 26 are provided further through the appropriate passageway in order to confirm that the person who entered the passage has, in fact, passed through the door.

The entry sensor arrays 25 typically comprises five sensors 29 as shown in FIG. 4a in order that most, if not all, of the radius of the door can be covered by this array. The five sensors are all directed substantially vertically to create a curtain of light. By curtain of light, it is meant a wall or veil of light having a height of substantially the height of the passageway (although the exact height can be adjusted by varying the focus length of the sensor beam), and at least sufficient height to prevent a person passing under the curtain, a width of substantially the radial dimension of the passageway and a depth of typically 25-50 mm. This five sensor array can be used for antitailgating or for antipiggybacking. A different number of sensors could be used depending upon the size (radius) of the door. When 3 sensors are used, as shown in FIG. 4b, the outer two sensors 27 are typically used to detect tailgating and the central sensor 28 for fraud detection of any person trying to gain passage by avoiding the outer tailgate sensors.

The exit sensor arrays 26 typically consist of two sensors and are used merely for passage confirmation and determination of whether any person is trapped within the door during an emergency situation and typically have the same arrangement shown in FIG. 4b, but without the central sensor 28, although the two sensors may also be directed substantially vertically.

All the sensors used are both emitters and detectors and therefore rely on reflection to generate a signal.

In the example shown in FIG. 4b, the two outer sensors 27 are angled towards one another and the central sensor 28 is mounted slight off vertical to ensure that reflection off the floor is not “detected”. In the situation in which greater than three sensors are utilised, the tilting of the outer sensors can be reduced or eliminated (FIG. 4a), depending upon the area which the array is desired to cover.

Although the sensors are continuously emitting infrared light, the processing means is programmed so as to ignore the wings of the door as they pass under the sensors.

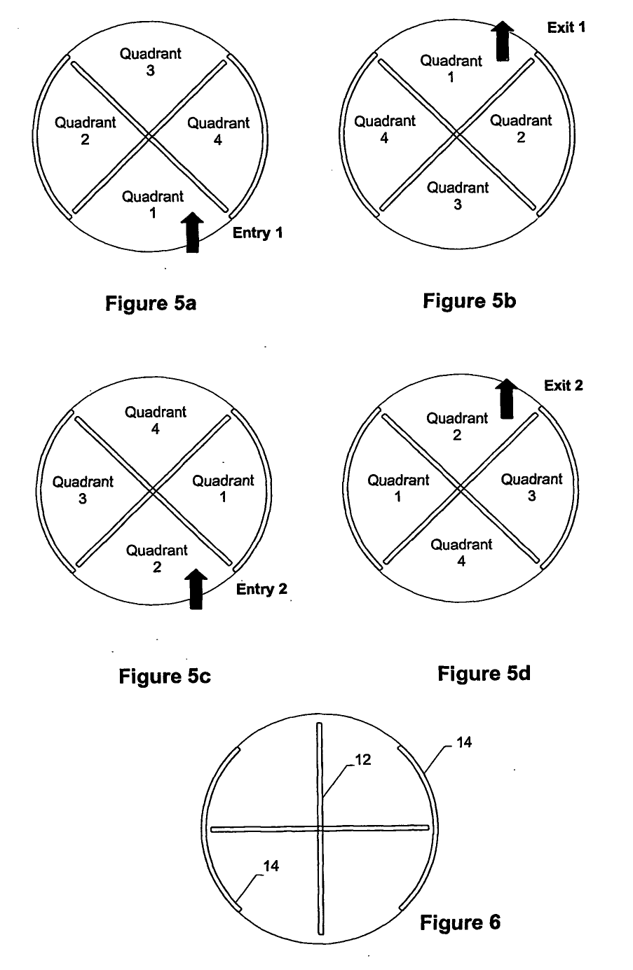

The operation of the device will now be described with reference to FIGS. 5A to D. Tailgating is the attempted entry of an unauthorised person in a second quadrant 2, following an authorised person in a first quadrant 1. The anti-tailgating facility operates as follows:

On a valid signal, if a user enters the door in quadrant 1 in FIG. 5A the door will commence rotation. Should an unauthorised person attempt to enter the door in quadrant 2 in FIG. 5C the door will continue to revolve as FIG. 5B to allow the user in quadrant 1 to vacate the door and stop any further revolutions. The presence of the unauthorised person in quadrant 2 will have been detected by sensor array 25 causing the door to reverse 90° at half speed to eject the person.

Alternatively, an antipiggybacking system operates as follows: on a valid signal, a user enters the door in quadrant 1 and as the door starts to rotate, a second user enters from the opposite direction into quadrant 3 without giving a valid signal. In this situation, the unauthorised person is detected by the relevant entry sensors 25 on the other side of the door and the processing means send the appropriate command so that the door will rotate 90° slow down, stop and reverse the occupants out of the door at half speed, thereby ensuring that the unauthorised person in quadrant 3 cannot pass through the door.

The door controller will give the access control system a passage cancellation output and the user who had been authorised to pass through the door will be required to re-badge for passage authorisation.

If, however, after a valid authorisation is given, the authorised user enters quadrant 2, rather than quadrant 1 (see FIG. 5C), the door will still rotate 180° to allow the authorised person to pass out of the door (FIG. 5D).

On a valid signal, if a user enters the door accompanied by a second person quadrant 1 in FIG. 5A the door will commence rotation. The presence of the two persons will be detected by the sensors array and the door will continue to revolve as FIG. 5C when a controlled stop will be initiated to prevent any further revolution. The controller with then reverse at half speed to eject the occupants back to the position shown in FIG. 5A.

The door controller will give the access control system a passage cancellation output and the user who had been authorised to pass through the door will be required to re-badge for passage authorisation.

Door rotation is started on receipt of an input from the connected access control device, such as a card reader (not shown). Once started, the door will rotate 180°. If another signal is received prior to completion of the first rotation, a further 180° rotation is authorised from the position at which the second input is received. This allows continuous use of the door, quadrant by quadrant, without any intermediate stops.

When no further inputs are received from the access control device, the door decelerates and stops. Although it is preferable for a user to enter the door at the first quadrant after passage has been authorised, it is also permissible to use the second quadrant. In this case, the sensor system will detect this action and rotate the door a further 90° to allow the authorised person to exit the door. The door can be used simultaneously for both authorised entry and exit passages so long as both occupants have authorisation. An authorised person using the door in the quadrant following an authorised person assuming that the second person's passage is also authorised.

Although not shown, the system may also include an anti-passback system such that passage is not permitted twice in the second direction using the same access validation. In order for this system to work, it is necessary for the access control computer to track usage of the validation and, additionally, confirm that a person has actually passed through the door. This can be achieved by using the system of the present invention which sends an immediate signal to the access control system once the occupant has passed a point of no return (e.g. the exit sensors 26) during the operational cycle.

In an emergency situation or in the event of power failure, the revolving door member 12 automatically reverts to the orientation in FIG. 6 to ensure that any persons in the door are able to exit it.

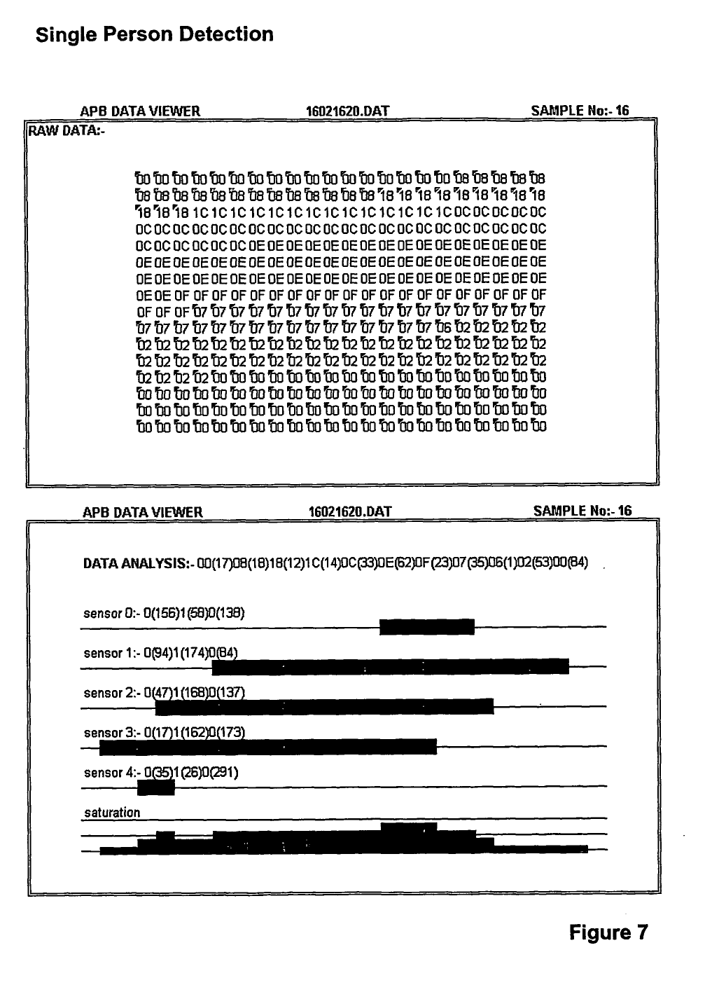

FIGS. 7 to 11 show, at the top, the raw data obtained from a sample array under various passage conditions and the lower half of the figures show the raw data interpreted into a bit map for ease of visual identification. FIG. 7 relates to the passage of a single person through the device and it will be noted how the outer sensors, sensors 0 and 4 are activated for only a short time, whereas the middle three sensors are activated for a longer time.

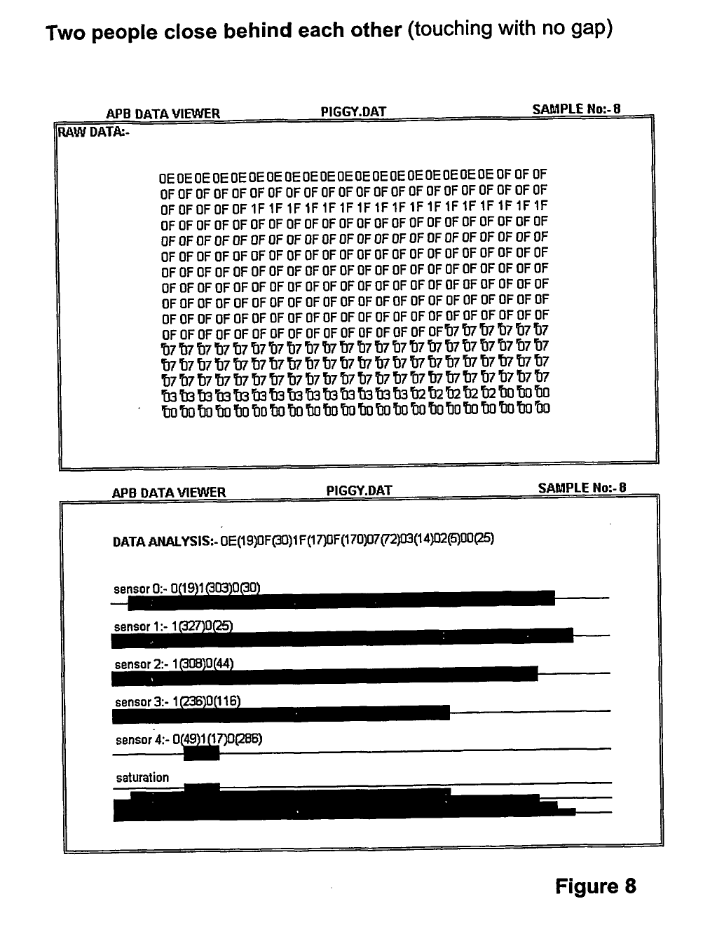

FIG. 8 shows an example whereby two people pass closely behind each other in the same quadrant and it will be noted how sensor 0, which in the previous example had been activated for a very short time, is now activated for approximately as long as the middle three sensors. In this example, a rejection order would be sent based upon the duration of the beam break from the sensors, i.e. the beam was broken for a longer time period than allowed in the operating parameters, thereby indicating that two persons were in the quadrant. This is either as saturation of the array i.e. too many sensors are activated at the same time as shown by the peak above the “saturation” line in FIG. 8, indicative that all 5 sensors were activated at the same time, or one or more sensors is activated for too long.

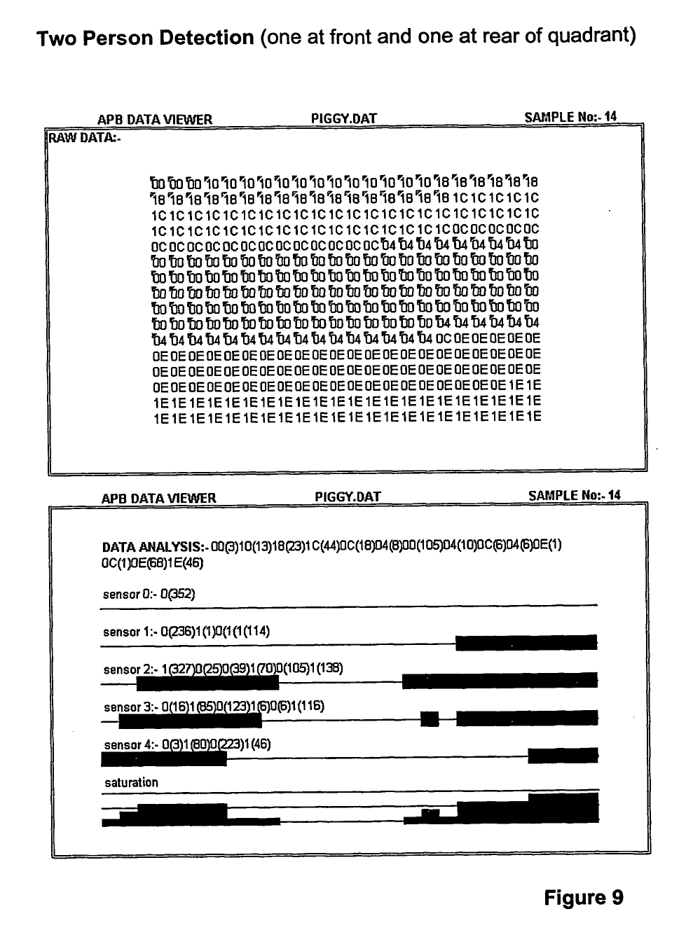

FIG. 9 shows the example where two people enter the same quadrant, one at the front and one at the rear. Over the time of the data, a clear gap between the two people passing can be noted, in particular, on sensors 2, 3 and 4 and, for this reason, a rejection order would be sent. In this example, the rejection is based on the beams being broken, returning to normal and then being rebroken, all within the time taken for a single quadrant to pass under the sensor array.

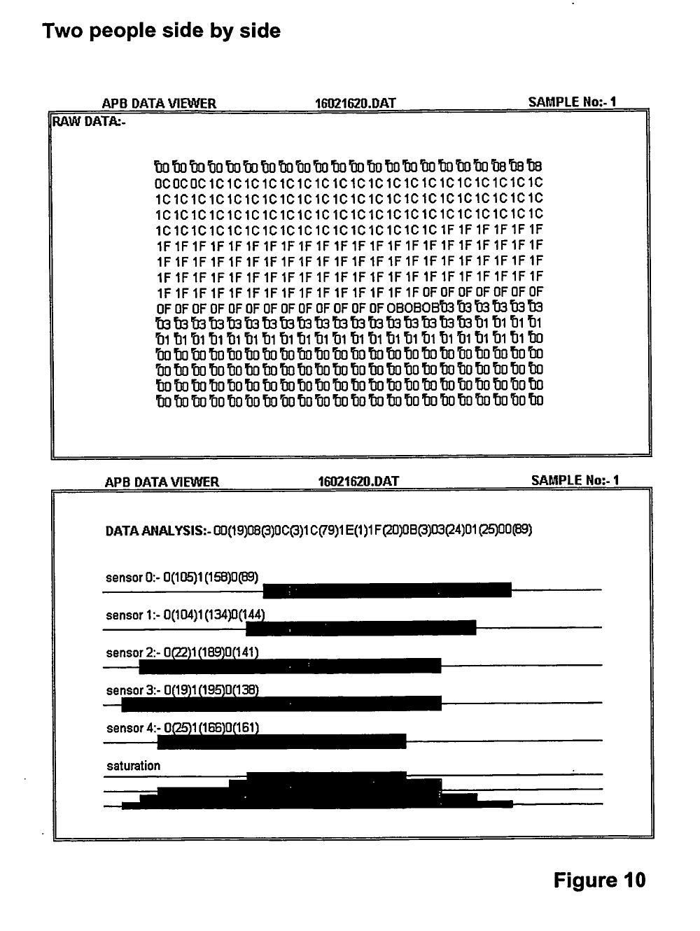

FIG. 10 shows the data from two people travelling through a single quadrant side by side and it will be noted how the outer sensors, sensors 0 and 4, had been activated for a time substantially equal to the middle sensors, indicative of this particular type of unauthorised passage. A rejection order would be sent on the basis of this. Again this is by saturation of the array, indicated by the two peaks above the saturation line or by sensors 0 and 4 being activated for a time period longer than permitted by the system parameters.

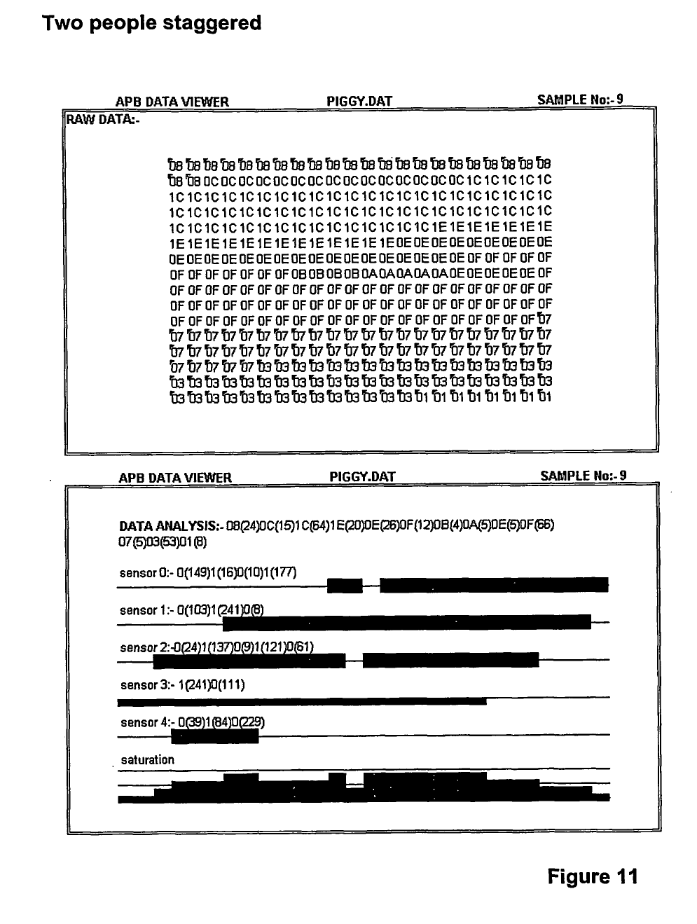

FIG. 11 is data indicative of two people in the same quadrant in a staggered arrangement, i.e. two people slightly side by side with one trailing the first. Rejection can be based upon the length of the beam brake, the number of sensors with beam brakes and the momentarily gaps in the signals.

In operation, data from the sensors 29 is collected on the clocked position signals of the movement of the door wings 13 through 90 degrees. There are 225 clock positions in a 90 degree quadrant so data is collected every 24 minutes of the door movement. In practice, the door wing 13 obscures the sensors 29 for the first 8 degrees and as the braking distance of the door is 12 degrees, the relevant segment of usable data is 70 degrees (175 clock positions).

Because the decision to stop the door is required at the same time as the data collection process completes, it is necessary to process the data as it is collected. To this end, a set of accumulators, alert flags and factor registers within control software are initialized at the start of each quadrant to parameter values that are pre-settable for varying levels of security.

These parameters are: the sensors minimum on or off count; the sensors maximum on count; the maximum value of the calculated “Saturation” and a start up value called pre-compensation which allows for errors caused by the acceleration of the door. As each sensor byte is received, a value is assigned to it, based on each sensor's radial position and on or off state, on alert factors for individual sensors and on alert factors for the group of sensors. This value is added to the saturation value and, should it exceed the pre-set maximum, the piggy-back alarm is given.

The alert factors for individual sensors are: exceeding the maximum on count; and more than one on/off cycle that exceeds the minimum on/off count.

The group alert factors are generated by the logical recognition of isolated on conditions or surrounded off conditions. These factors grow in significance as they continue, but cancel if a subsequent condition cancels the alert.

The pre-compensation factor progressively includes data that it omits at the start of the cycle and is applied to the first quadrant as the door starts to move. Although the data samples are collected on the position of the door and not time, which should make this unnecessary, it has been found, in subjective wording, that people have a tendency to hesitate at the entrance of the door while the wing starts to move away from them. This has the effect of exaggerating their size.

At any point in the cycle, the outer most and inner most on condition sensors are given increased tolerance for minimum on/off count and this compensates for the lateral movement of people as they walk.

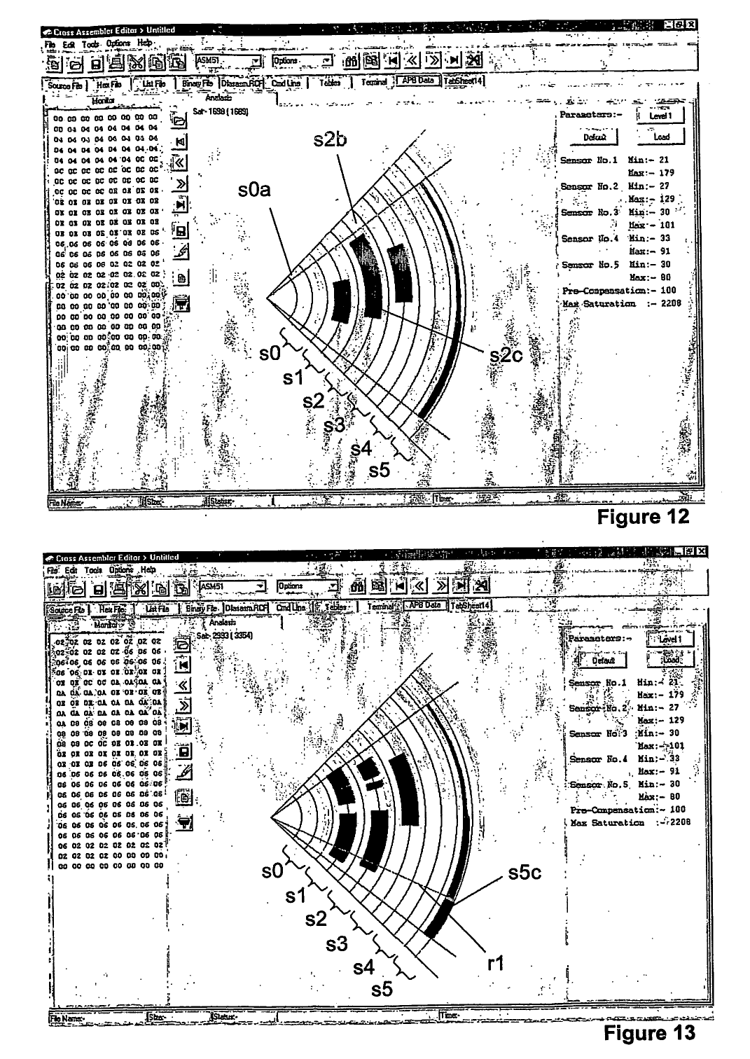

FIGS. 12 to 14 show further test results and analysis using control software. In the Figures, the left of screen represents sensor bit map data, the centre shows a pie graphical representation of the data and parameters, and the right of screen details the particular system parameters. As with the previous examples, five sensors (0 to 4 (N) as in the previous examples) are in the array and, in FIGS. 12 to 14, each sensor is represented by 3 arcs—a narrow, light coloured arc representing sensor minimum values sNa, a darker, narrow arc representing sensor maximum values sNb and a wide dark arc sNc representing sensor data. The sensor data (for the outermost sensors, s0 and s4,

The outermost group of arcs, group s5, represent the “APB system” values where the narrow darker arc s5b represents the trip value (maximum saturation), the narrow light coloured arc s5a represents pre-compensation and the width of the wider dark arc s5c represents accumulative “saturation” level.

FIG. 12:—One person

In this graph we see that, although an alert was generated as the trace for sensor 3 exceeds the maximum “on” count, i.e. the total length of the sensor data arc s2c exceeds the length of the trip value arc s2b, as there are no other alarms in the rest of the quadrant, passage is allowed.

FIG. 13:—Two people in tandem.

In this graph we see an alert generated by the second turn on of sensors s1 and s2 and the consequent increase in the saturation ramp in arc s5c. As these two sensors also exceed their maximum “on” count, i.e. the total combined length of the multiple portions of each sensor data arcs s1c and s2c exceeds the length of the respective trip value arc s1b and s2b, two more alerts cause the maximum saturation to be exceeded, shown by the increased width of arc s5c and a piggyback alarm is indicated by the radius line r1.

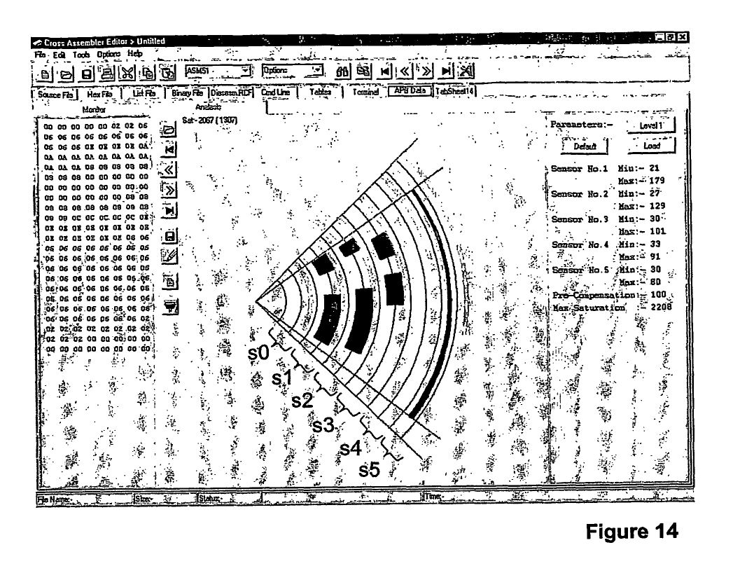

FIG. 14:—Eliminating some of the common causes for unnecessary rejections.

This graph was produced by one person walking through the door with their right hand on the wing glass (as if pushing it). Because the sensor minimum “on/off” count parameters sNa are not exceeded, the system determines that their arm is of insufficient mass to be another person, i.e. the sensors have not been activated for long enough for two people to be in the quadrant, no alerts are generated and the calculation of the total trace yields saturation s5c are within the maximum level.

1. A system for monitoring the passage of people through a controlled location, the system comprising:
a security access device for selectively allowing and preventing the passage of one or more people through the controlled location;
an array of imaging sensors which, in use, emit a curtain of light and detect reflected light from people through the curtain of light to generate image data; and,
processing means for analysing characteristics of the reflected image data for each sensor in the array and controlling the operation of the security access device in dependence on the analysis;
wherein the processing means determines at least one of the following characteristics for the array of sensors; duration of signal from each sensor, number of signals for each sensor and the saturation of the array.

2. A system according to claim 1, wherein the imaging sensors continuously emit the light.

3. A system according to either claim 1 or claim 2, wherein the sensors emit infrared light.

4. A system according to any one of the preceding claims, further comprising a second array of sensors.

5. A system according to any one of the preceding claims, wherein the array scans an area adjacent the entry to the security access device.

6. A system according to claim 4 or claim 5, wherein the second array scans an area adjacent to the exit from the security access device.

7. A system according to any one of the preceding claims, wherein the security access device is a resolving door.

8. A system according to any one of the preceding claims, wherein the array comprises a row of at least three sensors.

9. A system according to any one of claims 4 to 8, wherein the second array comprises two or more sensors.

10. A system according to any one of the preceding claims, further comprising a drive means for rotating and/or preventing rotation of the security access device.

11. A method of monitoring the passage of people through a controlled location, the method comprising the steps of:
emitting a curtain of light through which any person moving through the controlled location must pass;
sensing the number of people on a portion of the controlled location;
determining whether to allow or prevent passage through the controlled location; and
driving a security access device to allow or prevent passage through the controlled location in response to the determination.

12. A method according to claim 11, further comprising the step of rotating the security access device so as to eject one or more people from the controlled location in the event that passage is to be prevented.

13. A system of monitoring the passage of people through a controlled location, the system comprising:
means for emitting a curtain of light through which any person moving through the controlled location must pass;
means for sensing the number of people in a portion of the controlled location;
means for determining whether to allow or prevent passage through the controlled location; and
means for driving a security access device to allow or prevent passage in response to the determination.

14. A system according to claim 13, further comprising means for rotating the security access device so as to eject one or more people from the controlled location in the event that passage is to be prevented.
